(19) United States
(12) Patent Application Publication
(10) Pub. No.: US 2016/0318737 A1
(43) Pub. Date: Nov. 3, 2016

(54) ELEVATOR

(71) Applicant: KONE Corporation, Helsinki (FI)

(72) Inventor: Harri JOKI, Tampere (FI)

(73) Assignee: KONE Corporation, Helsinki (FI)

(21) Appl. No.: 15/204,790

(22) Filed: Jul. 7, 2016

Related U.S. Application Data
(63) Continuation of application No. PCT/EP2015/052745, filed on Feb. 10, 2015.

(30) Foreign Application Priority Data
Feb. 11, 2014 (EP) 14154640.8

(51) Int. Cl. B66B 7/06; B66B 11/04; B66B 15/04; B66B 9/00

(52) U.S. Cl. CPC B66B 7/062; B66B 9/00; B66B 11/043; B66B 15/04

(57) ABSTRACT

An elevator includes an elevator car and a suspension roping suspending the elevator car. The suspension roping includes at least one suspension rope connected to the elevator car. Each of the at least one rope includes one or more load bearing members embedded in an elastomeric coating forming the outer surface of the rope, and a rotatable traction member engaging the outer surface of the at least one rope. The elevator further includes a drive for rotating the rotatable traction member. The elastomeric coating is made of microcellular elastomer, whereby the rope can receive excessive substance, such as water, and transport it away from the contact between the rope and the rotatable traction member.

### FIELD OF THE INVENTION

The invention relates to an elevator, in particular to an elevator, which is suitable for transporting passengers and/or goods.

### BACKGROUND OF THE INVENTION

In elevators, such as so called traction wheel elevators, it is common that the elevator car is suspended by suspension roping comprising several suspension ropes passing over a rotatable traction member, which is usually in the form of a traction wheel. The traction wheel is generally driven by a motor under control of a control system whereby transport of the elevator car upwards or downwards can be carried out in an automatized manner. The suspension ropes are typically engaged frictionally by the traction wheel.

In prior art, there are such ropes which have their load bearing member(s) coated with elastomeric material. There are various reasons for this. By coating, it is for example possible to adjust, usually aiming to increase, the power transmitting ability over the frictional engagement between the rope and the rotatable traction member. The coating can also provide additional or alternative functions for the rope, such as protection for the load bearing members. Also, the coating may be used for binding several load bearing members together.

A problem with known hoisting solutions has been that substantial drops in friction between the coated ropes and the traction wheel may cause occurrence of unintended slipping of the ropes along the traction wheel. Especially, if water or any other liquid such as substances containing oil or any other lubricant, gets trapped between the rope and the traction wheel, drops of friction properties are likely to be caused which may lead to unintended slipping. It would be optimal if occurrence of any unintended slipping could be avoided so as to prevent any uncontrolled behavior of the elevator.

### BRIEF DESCRIPTION OF THE INVENTION

The object of the invention is, inter alia, to solve previously described drawbacks of known solutions and problems discussed later in the description of the invention. The object of the invention is to introduce an elevator, which is improved in terms of the frictional engagement between the hoisting ropes and the traction member of the elevator. It is an object, inter alia, to improve adaptability of the hoisting ropes to situations where any excessive substance is drifted into contact with the rope, but particularly into the nip between the traction wheel and the rope. Embodiments are presented, inter alia, which facilitate avoiding unintended slipping in situations where liquids, such as water, oil or any other excessive material is drifted into the nip between the traction wheel and the rope.

It is brought forward a new elevator comprising an elevator car and a suspension roping suspending the elevator car, the suspension roping comprising at least one suspension rope connected to the elevator car, wherein each of said at least one rope comprises one or more load bearing members embedded in an elastomeric coating forming the outer surface of the rope, and a rotatable traction member engaging said outer surface formed by the elastomeric coating. The elevator furthermore comprises means for rotating the rotatable traction member. The elastomeric coating is made of microcellular elastomer. Thus, it is porous which makes it suitable for receiving small amounts of substances such as liquids, which get into contact with the rope, such as between the rope and the rotatable traction member, and transport the excessive substance away, particularly from the contact between the rope and the rotatable traction member. Thereby, unintended slipping caused by the excessive substance between the rope and the rotatable traction member can be avoided.

In a preferred embodiment the elastomeric coating is made of microcellular polyurethane. This material is known to be well suitable for traction-engagement in elevator use, as it has good frictional properties and good wear resistance, and it is commercially widely available.

In a preferred embodiment the rope is in the form of a belt. The belt-shaped rope is particularly arranged to pass around and against the circumference of the rotatable traction member turning around its width direction, its wide side in contact with the traction surface of the rotatable traction member, which the traction surface is formed by the circumference of the rotatable traction member. The coating made of microcellular elastomer is particularly advantageous in context of elevators using belts as suspension ropes. Occurrence of unintended slipping is most problematic with belt-like ropes, because liquid or any other excessive substance drifting into the nip between the traction member and the rope cannot easily escape away from a wide nip area formed between the belt and the traction member.

In a preferred embodiment the elastomeric coating has outwards open (i.e. open to the outside of the rope) hollow cavities suitable for receiving at least liquid substance from outside of the rope, but preferably also any other excessive substances from outside of the rope. The cavities can quickly receive the excessive substance, such as free water, when it gets into contact with the elastomeric coating, and transport the excessive substance away from proximity of the rotatable traction member.

In a preferred embodiment the elastomeric coating has outwards open (i.e. open to the outside of the rope) hollow cavities suitable for receiving at least liquid substance from outside of the rope, but preferably also any other excessive substances, in particular from the nip between the traction member and the rope, and the outwards open hollow cavities are fitted to pass against the traction surface of the rotatable traction member. The cavities can quickly receive the excessive substance, such as free water, from between the rope and the rotatable traction member, and transport it away from the contact area. In this way, the excessive substance cannot considerably cause slipping.

Particularly, formation of a vast slippery water layer between the rope and the rotatable traction member can in this way be prevented.

In a preferred embodiment the rotatable traction member engages frictionally the outer surface of said at least one rope. In particular, no positive engagement, such as intermeshing teeth, exists between the rope and the rotatable traction member. The coating made of microcellular elastomer reduces loss of contact between the ropes and the rotatable traction member, whereby it is particularly advantageous in this context where the engagement is dependent on frictional contact.

In a preferred embodiment the rope is in the form of a belt and comprises a plurality of said load bearing members spaced apart in width direction of the rope. The coating isolates the load bearing member from each other, whereby it also provides the function of prohibiting wear caused by chafing between the load bearing members.

In a preferred embodiment the rope is in the form of a belt and the traction surface of the rotatable traction member is cambered. Thus, the belt-shaped rope is provided lateral guidance as it passes around the traction wheel.

The elevator as describe anywhere above is preferably, but not necessarily, installed inside a building. The car is preferably arranged to serve two or more landings. The car preferably is arranged to respond to calls from landing(s) and/or destination commands from inside the car so as to serve persons on the landing(s) and/or inside the elevator car. Preferably, the car has an interior space suitable for receiving a passenger or passengers.

### BRIEF DESCRIPTION OF THE DRAWINGS

In the following, the present invention will be described in more detail by way of example and with reference to the attached drawings, in which

FIG. 1 illustrates an elevator according to a preferred embodiment.

FIGS. 2a to 2c illustrate alternative preferred cross sections for the rope.

FIG. 3 illustrates a partial cross-section of the contact between the rope and the rotatable drive member as viewed from the side.

FIG. 4 illustrates preferred further details for the embodiment of FIG. 1.

### DETAILED DESCRIPTION

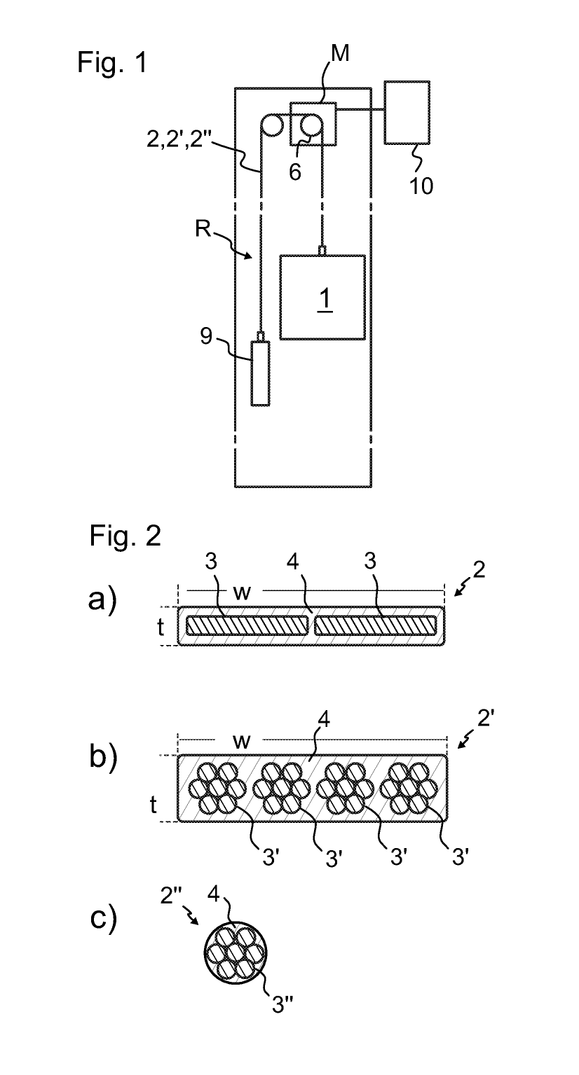

FIG. 1 illustrates a preferred embodiment of an elevator, which comprises an elevator car 1 and a suspension roping R suspending the elevator car 1 with at least one suspension rope 2,2′,2″, preferably a plurality of suspension ropes 2,2′,2″, connected to the elevator car 1. FIGS. 2a to 2c illustrate alternative cross sections for an individual rope 2,2′,2″. Each of said at least one suspension rope 2,2′,2″ comprises one or more load bearing members 3,3′,3″ embedded in an elastomeric coating 4 (i.e. the coating 4 is made of elastomer), the coating 4 forming the outer surface of the rope 2,2′,2″. Each of said at least one suspension rope 2,2′,2″ is engaged by a rotatable traction member 6 via said outer surface formed by the coating 4. The coating 4 is in contact with the rotatable traction member 6, in particular the traction surface thereof. Thus, the properties of the engagement between the rotatable traction member 6 and the rope 2,2′,2″, in particular firmness of the engagement, are substantially determined by the properties of the coating 4. The rotatable traction member 6 is preferably in the form of a traction wheel 6 around which the ropes pass, the rotatable traction member 6 being rotatable by a motor M under control of an elevator control system 10, as illustrated. However, also alternative means for rotating the rotatable traction member 6 can be used. In the preferred embodiment, the suspension ropes 2,2′,2″ are on one side of the rotatable traction member connected to the elevator car 1 and on the other side to a counterweight. Thereby the suspension roping R suspends also the counterweight 9 with said at least one suspension rope 2,2′,2″.

The elastomeric coating 4 is made of microcellular elastomer. Thus, it is porous which makes it suitable for receiving small amounts of water, or any other liquid such as substances containing oil or any other lubricant, which get between the rope 2,2′,2″ and the traction member 6, and transport it away from the contact between the rope 2,2′,2″ and the rotatable traction member 6. Ability to receive a small amount of liquid makes it possible to avoid formation of a vast water layer and thereby a contactless area between the rope 2,2′,2″ and the rotatable traction member 6. A contact and thereby a firm engagement can thus be maintained between the rope 2,2′,2″ and the rotatable traction member 6 even in case liquid substance gets between them. A fast moving rope 2,2′,2″ efficiently transports the liquid away from the contact area thereby efficiently drying the contact between the rope 2,2′,2″ and the rotatable traction member 6. An increase in tolerance for liquids is thus achieved, whereby unintended slipping in these situations can be avoided. Correspondingly, the porous coating 4 can receive small particles of solid substances from between the rope 2,2′,2″ and the traction member 6, and transport it away from the contact area.

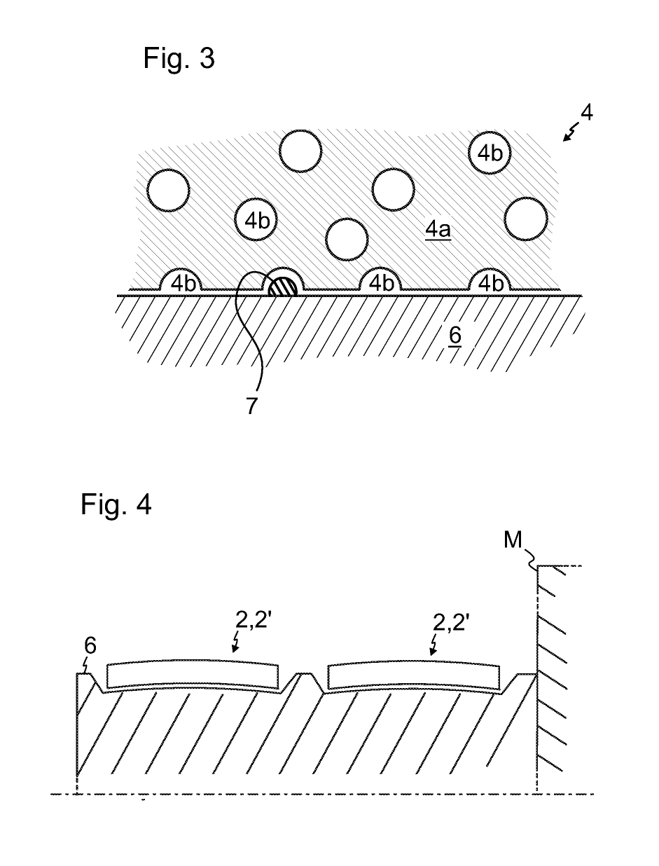

As more specifically illustrated in FIG. 3, the micro cellular elastomer comprises hollow cavities 4b in elastomer base material 4a suitable for receiving at least liquid 7 , but preferably also any other excessive substances, from outside of the rope 2,2′,2″. These cavities 4b can particularly receive the liquid from between the rope 2,2′,2″ and the rotatable traction member 6. As illustrated in FIG. 3, the coating 4 has on its outer surface outwards open (i.e. open towards outside of the rope) hollow cavities 4b for receiving liquid substance from outside of the rope 2,2′,2″, which hollow cavities 4b extend from the outside into the elastomer base material 4a. These outwards open cavities 4b give the rope a rough surface. The outwards open hollow cavities 4b are fitted to pass against the traction surface of the rotatable traction member 6. The cavities 4b can quickly receive the liquid, such as free water, particularly from the nip between the rope 2,2′,2″ and the rotatable traction member 6, whereby formation of a vast slippery water layer between the rope 2,2′,2″ and the rotatable traction member 6 is prevented. As the rope 2,2′,2″ compresses closer towards the rotatable traction member 6 it displaces the water into the cavities 4b of the rough rope surface and portions of the rope surface which are between the cavities 4b can reach into contact with the rotatable traction member 6. The cavities being small in size makes it possible that the capillary action enhances the removal of the water from the nip between the rope 2,2′,2″ and the rotatable traction member 6.

The coating 4 is most preferably made of microcellular polyurethane, which is known to be well suitable for traction-engagement in elevator use, as it has good frictional properties and good wear resistance, and it is commercially widely available. This material can be manufactured by adding into the polyurethane base material, when it is still in solution phase, an additive substance that can form the cellular structure into the polyurethane base material. In particular, the additive substance for forming the cellular structure can be one activatable by heat (reaction heat or external heat), which when heated disintegrates and forms the microcellular structure for the polyurethane, Alternatively, the coating may be of any other microcellular elastomer.

The rope 2,2′,2″ may be round in cross-section or in the form of a belt. FIGS. 2a to 2b illustrate an alternative where the rope 2,2′ is in the form of a belt, whereby it has substantially greater width w than thickness in transverse direction of the rope. In these embodiments, the rope 2,2′ comprises a plurality of said load bearing members 3,3′ spaced apart in width direction of the rope 2,2′ and isolated from each other by the coating 4. In these embodiments, the coating additionally serves as a means for positioning the load bearing members relative to each other. Alternatively, each rope 2,2′ could be formed to have a greater or smaller number of load bearing members 3,3′. FIG. 2c illustrates an embodiment where the rope 2″ has a round cross section.

FIG. 4 illustrates a configuration implementing a rope 2,2′ described earlier above. FIG. 4 shows how the rope 3,3′ and the rotatable traction member 6 are positioned relative to each other. The internal structure of the rope has not been illustrated, but it is preferably as described and illustrated earlier in context of FIG. 2a or 2b. The rope 2,2′ is in the form of a belt and has a wide surface face (lower face in FIG. 4) formed by the coating 4 and fitted against a traction surface (upper face in FIG. 4) of the rotatable traction member 6. In this case the traction surface of the rotatable traction member 6 is slightly cambered, whereby the rope 2,2′ is provided lateral guidance as it passes around the traction wheel 6. The rope 2,2′ does not have teeth, and the rotatable traction member 6 engages the outer surface of said at least one rope 2,2′ frictionally without positive engagement.

It is to be understood that the above description and the accompanying Figures are only intended to illustrate the present invention. It will be apparent to a person skilled in the art that the inventive concept can be implemented in various ways. The invention and its embodiments are not limited to the examples described above but may vary within the scope of the claims.

1. An elevator comprising:
an elevator car; and
a suspension roping suspending the elevator car, the suspension roping comprising at least one suspension rope connected to the elevator car,
wherein each of said at least one suspension rope comprises:
one or more load bearing members embedded in an elastomeric coating forming an outer surface of the rope; and
a rotatable traction member engaging the outer surface of said at least one suspension rope; and
a drive for rotating the rotatable traction member,
wherein the elastomeric coating is made of microcellular elastomer.

2. The elevator according to claim 1, wherein the elastomeric coating is made of microcellular polyurethane.

3. The elevator according to claim 1, wherein the at least one suspension rope is in the form of a belt.

4. The elevator according to claim 1, wherein the elastomeric coating has outwards open hollow cavities for receiving at least a liquid substance.

5. The elevator according to claim 1, wherein the elastomeric coating has outwards open hollow cavities for receiving at least a liquid substance, and the outwards open hollow cavities are fitted to pass against the traction surface of the rotatable traction member.

6. The elevator according to claim 1, wherein the rotatable traction member engages frictionally the outer surface of said at least one suspension rope.

7. The elevator according to any of the preceding claim 1, wherein the at least one suspension rope is in the form of a belt and comprises a plurality of said load bearing members spaced apart in width direction of the at least one suspension rope.

8. The elevator according to claim 1, wherein the at least one suspension rope is in the form of a belt and the traction surface of the rotatable traction member is cambered.

9. The elevator according to claim 1, wherein the drive for rotating the rotatable traction member comprises a motor and an elevator control system.

10. The elevator according to claim 2, wherein the at least one suspension rope is in the form of a belt.

11. The elevator according to claim 2, wherein the elastomeric coating has outwards open hollow cavities for receiving at least a liquid substance.

12. The elevator according to claim 3, wherein the elastomeric coating has outwards open hollow cavities for receiving at least a liquid substance.

13. The elevator according claim 2, wherein the elastomeric coating has outwards open hollow cavities for receiving at least a liquid substance, and the outwards open hollow cavities are fitted to pass against the traction surface of the rotatable traction member.

14. The elevator according claim 3, wherein the elastomeric coating has outwards open hollow cavities for receiving at least a liquid substance, and the outwards open hollow cavities are fitted to pass against the traction surface of the rotatable traction member.

15. The elevator according claim 4, wherein the elastomeric coating has outwards open hollow cavities for receiving at least a liquid substance, and the outwards open hollow cavities are fitted to pass against the traction surface of the rotatable traction member.

16. The elevator according to claim 2, wherein the rotatable traction member engages frictionally the outer surface of said at least one rope.

17. The elevator according to claim 3, wherein the rotatable traction member engages frictionally the outer surface of said at least one rope.

18. The elevator according to claim 4, wherein the rotatable traction member engages frictionally the outer surface of said at least one rope.

19. The elevator according to claim 5, wherein the rotatable traction member engages frictionally the outer surface of said at least one rope.

20. The elevator according to claim 2, wherein the at least one suspension rope is in the form of a belt and comprises a plurality of said load bearing members spaced apart in width direction of the at least one suspension rope.
